(19) United States
(12) Patent Application Publication
(10) Pub. No.: US 2023/0284781 A1
(43) Pub. Date: Sep. 14, 2023

(54) TRAVEL PILLOW

(71) Applicant: Ningbo Usun Products Design Co., Ltd., Ningbo (CN)

(72) Inventor: Wenguo GE, Ningbo (CN)

(21) Appl. No.: 18/198,254

(22) Filed: May 16, 2023

Related U.S. Application Data
(63) Continuation-in-part of application No. PCT/CN2021/135301, filed on Dec. 3, 2021.

(30) Foreign Application Priority Data
Feb. 5, 2021 (CN) 202110162678.X

(51) Int. Cl. A47C 7/38; A47G 9/10; A61H 99/00

(52) U.S. Cl. CPC A47C 7/383; A47G 9/1036; A47G 9/1009; A47G 9/1081; A61H 99/00; A61H 2201/0207; A61H 2201/107

(57) ABSTRACT

A travel pillow includes a main body, at least one module, and a rotary frame. The main body includes at least one compartment. The at least one module is detachably disposed in the at least one compartment; and the rotary frame is disposed on the outer side of the main body. The rotary frame includes a support arm, a rear support part, and an angle adjustment assembly. The support arm is rotatably connected to the rear support part, and the angle adjustment assembly is disposed between the support arm and the rear support part to adjust an angle between the support arm and the rear support part; and the angle adjustment assembly includes a rotating shaft and a damper rotatably sleeving the rotating shaft. The support arm includes a first socket ring. The rear support part includes a second socket ring.

### CROSS-REFERENCE TO RELATED APPLICATIONS

This application is a continuation-in-part of International Patent Application No. PCT/CN2021/135301 with an international filing date of Dec. 3, 2021, designating the United States, now pending, and further claims foreign priority benefits to Chinese Patent Application No. 202110162678.X filed Feb. 5, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a travel pillow.

Conventional travel pillows are single-functional, only to prop up users' heads and necks to rest, without massage and heating functions. Some travel pillows are equipped with massage and heating modules; however, they are bulky, heavy, inconvenient to carry.

### SUMMARY

The disclosure provides a travel pillow; the travel pillow comprises a main body, the main body comprising at least one compartment; at least one module, the at least one module being detachably disposed in the at least one compartment; and a rotary frame disposed on an outer side of the main body. The rotary frame comprises a support arm, a rear support part, and an angle adjustment assembly; the support arm is rotatably connected to the rear support part, and the angle adjustment assembly is disposed between the support arm and the rear support part to adjust an angle between the support arm and the rear support part; and the angle adjustment assembly comprises a rotating shaft and a damper rotatably sleeving the rotating shaft; the support arm comprises a first socket ring; the rear support part comprises a second socket ring; the first socket ring is connected to the support arm and sleeves the rotating shaft; and the second socket ring is connected to the rear support part and sleeves the rotating shaft.

The at least one compartment is disposed on the main body; the at least one module is detachably disposed in the at least one compartment, so that the at least one module can be disposed in any desired position thus satisfying the requirements of users. The support arm is rotatably connected to the rear support part, and the angle adjustment assembly is disposed between the support arm and the rear support part to adjust an angle between the support arm and the rear support part. Thus, the angle between the support arm and the rear support part is adjusted by the angle adjustment assembly to help the user's neck stay comfortable. The support arm and the rear support part sleeve the rotating shaft; the damper is used in conjunction with the rotating shaft to arrest the support arm in any position, thus enhancing user experience.

In a class of this embodiment, the at least one module is a massage module, a heating module, a blowing module, or a combination thereof.

Specifically, the at least one module is a massage module, a heating module, a blowing module, or a combination thereof; the massage module is configured to massage users, the heating module is configured to provide heat energy to users, and the blowing module is configured to provide airflow to users.

In a class of this embodiment, the travel pillow further comprises a snap connector disposed between the at least one module and the at least one compartment.

Thus, the at least one module is fastened to the at least one compartment by the snap connector.

In a class of this embodiment, the snap connector comprises a snap disposed on the at least one module, and a slot disposed on the at least one compartment; and the at least one module is fastened to the at least one compartment through the cooperation of the snap and the slot.

Thus, the at least one module can be fixed in or detached from the at least one compartment.

In a class of this embodiment, the at least one module is connected to the at least one compartment in a sliding way.

Thus, the at least one module is conveniently connected to the at least one compartment.

In a class of this embodiment, a slide rail is disposed on the at least one compartment; the at least one module comprises a slider movable along the slide rail; so that the at least one module is slidably connected to the at least one compartment through the cooperation of the slide rail and the slider.

Specifically, the slide rail is disposed on the at least one compartment; the at least one module comprises the slider movable along the slide rail; so that the at least one module is slidably connected to the at least one compartment through the cooperation of the slide rail and the slider; in addition, the at least one module can be detached from the at least one compartment through the cooperation of the slide rail and the slider.

In a class of this embodiment, the main body is bent to form a notch; the travel pillow further comprises a pressure part comprising a pressure surface; the main body comprises an external surface back against the notch; the pressure part is disposed on the external surface; and the pressure surface is a flat surface.

The notch is configured to receive the user's neck and head; the pressure surface is flat and positioned against an object to ensure the user's neck is propped up at a comfortable angle; the pressure part can be detached from the travel pillow; a joint between the pressure part and the main body can also be positioned against an object.

In a class of this embodiment, the travel pillow further comprises a casing, a filler, and a tab; the casing is disposed on the exterior surface of the main body; the filler is disposed between the casing and the main body; the tab is connected to the filler and allows the travel pillow to be placed on a hook.

When the user wears the travel pillow, the tab hangs down and covers the zipper of the pillow; when the travel pillow is not in use, the travel pillow is hung on the hook through the tab.

The following advantages are associated with the travel pillow of the disclosure:

1. The at least one module is detachably disposed in the at least one compartment, which allows for easy replacement of different functional modules.

2. The at least one module is fixedly disposed on the main body using a snap connector or a slide rail, which allows for convenient assembly and disassembly of the travel pillow.

3. The travel pillow is an ergonomic pillow designed to support the user's neck; the pressure surface is a flat surface that is positioned against an object to ensure the user's neck can be propped up at a comfortable angle.

4. The angle between the support arm and the rear support part is adjusted by the angle adjustment assembly to help a user's neck stay comfortable.

5. The travel pillow is easy to carry; when the user is wrapped into the travel pillow, the tab hang down to cover the zipper; when the travel pillow is not in use, the travel pillow is hung on the hook through the tab.

### BRIEF DESCRIPTION OF THE DRAWINGS

FIG. 1 is a perspective view of a travel pillow according to Example 1 of the disclosure;

FIG. 2 is another perspective view of a travel pillow in FIG. 1;

FIG. 3 is an exploded view of a travel pillow in FIG. 1;

FIG. 4 is a perspective view of a rotary frame in FIG. 3;

FIG. 5 is a local enlarged view of part I in FIG. 4;

FIG. 6 is a cross-sectional view of an angle adjustment assembly according to one example of the disclosure;

FIG. 7 is a perspective view of a rotating shaft in FIG. 6;

FIG. 8 is a perspective view of a damper in FIG. 6; and

FIG. 9 is another perspective view of a travel pillow in FIG. 1.

In the drawings, the following reference numbers are used: 100. Travel pillow; 10. Module; 20. Main body; 21. Groove; 30. Rotary frame; 31. Support arm; 32. Angle adjustment assembly; 33. First socket ring; 34. Second socket ring; 35. Rear support part; 36. Connection part; 40. Rotating shaft; 41. Second fixing part; 42. Damping part; 41a. Threaded end; 41b. Threaded nut insert; 50. Damper; 51. First fixing part; 51a. External thread; 52. Adjustment end; 53. Adjustment section; 53a. First adjustment section; 53b. Second adjustment section; 60. Casing; 61. Pressure part; and 70. Tab.

### DETAILED DESCRIPTION

To further illustrate the disclosure, embodiments detailing a travel pillow are described below. It should be noted that the following embodiments are intended to describe and not to limit the disclosure.

### Example 1

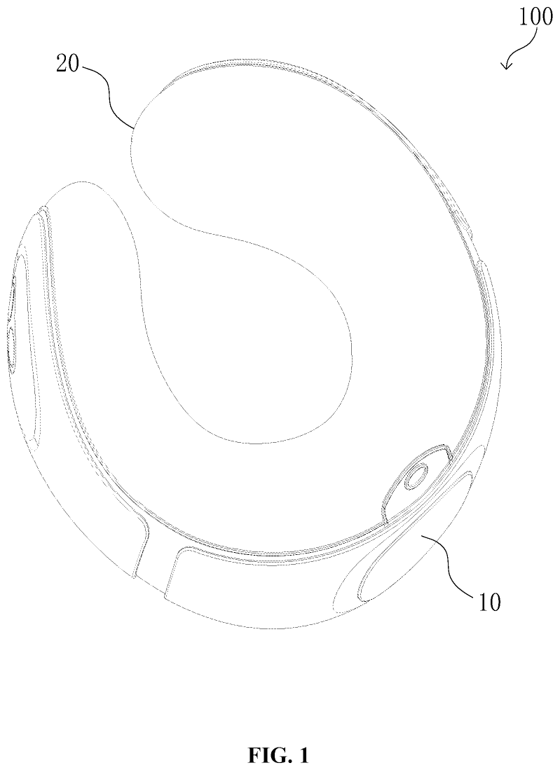

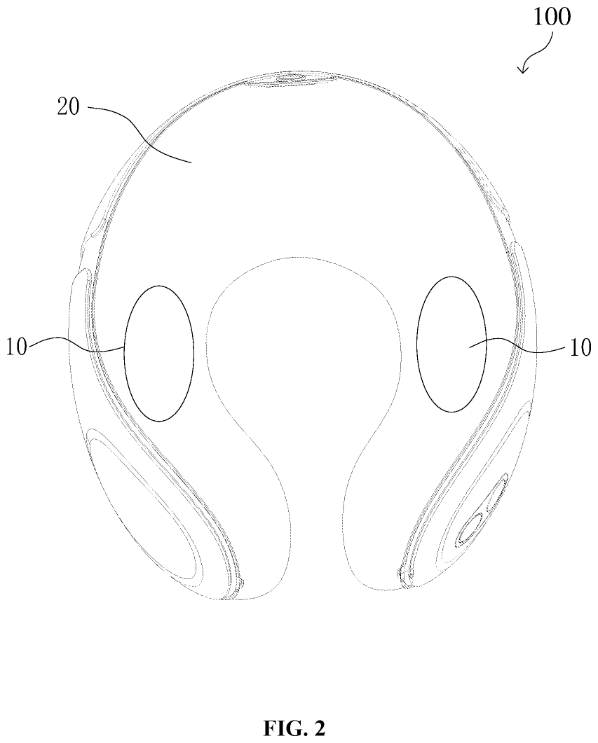

As shown in FIG. 1, a travel pillow 100 comprises a main body 20, at least one compartment (not shown), and at least one module 10. Referring to FIGS. 1 and 2, the at least one compartment is disposed on the main body 20; the main body 20 comprises a rear end and two sides; the at least one compartment is disposed on the rear end, the two sides, or any other parts that enables the travel pillow 100 to function as described herein.

In certain examples, the at least one module 10 is detachably disposed in the at least one compartment, so that the at least one module can be disposed in any desired position to satisfy the requirements of users.

In certain examples, the at least one module 10 comprises a massage module for applying massage to users, a heating module for providing heat energy to users, and a blowing module for blowing air to users, or a combination thereof. For examples, the travel pillow 100 comprises a first compartment disposed in the rear end of the main body 20, two second compartments disposed in both sides of the main body 20, a massage module, and two heating modules; the massage module is disposed in the first compartment, and two heating modules are respectively disposed in the two second compartments, to support the heat option and massage at the same time.

In certain examples, the at least one compartment further comprises at least one foam which is comfortable to the user's neck. Understandably, the travel pillow 100 may use different combinations of these modules and is not described in detail herein.

In certain examples, the at least one module 10 is fixedly disposed in the at least one compartment by a snap connector; the snap connector comprises a snap and a slot detachably connected to the snap.

In certain examples, the travel pillow 100 further comprises a slide rail disposed on the at least one compartment; the at least one module 10 comprises a slider movable along the slide rail, and thus the at least one module 10 can be fixed in or detached from the at least one compartment. Optionally, the at least one module 10 is fixedly disposed in the at least one compartment using a snap fit or other connection means.

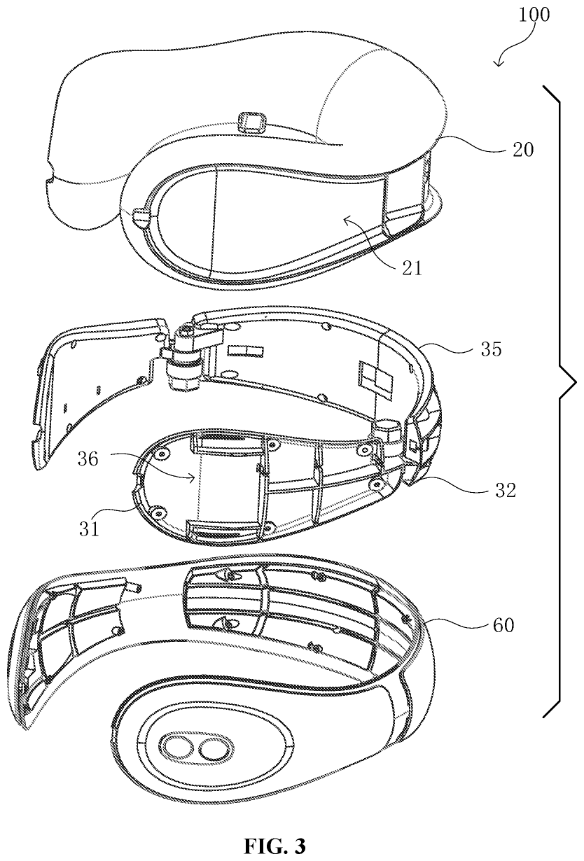

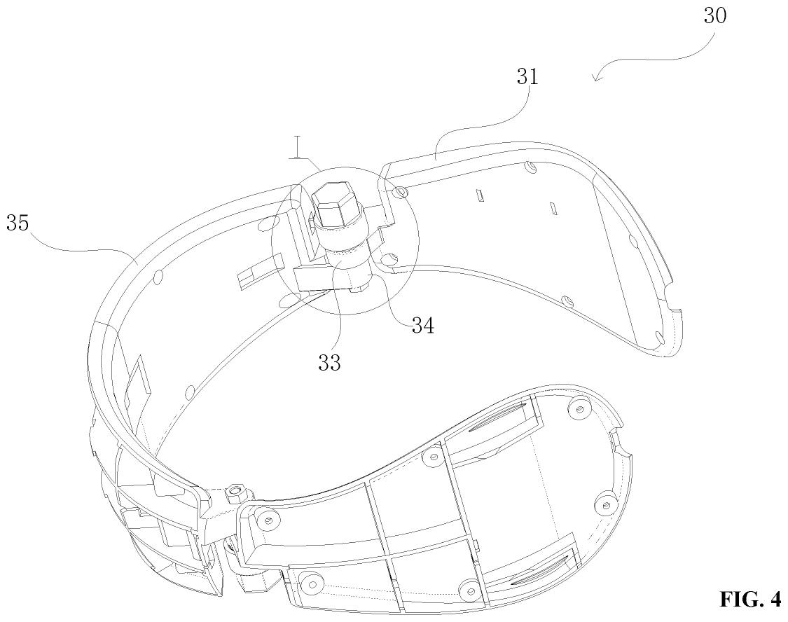

Preferably, as shown in FIGS. 3-4, the travel pillow 100 further comprises a rotary frame 30; the rotary frame 30 comprises a support arm 31, a rear support part 35, and an angle adjustment assembly 32. The support arm 31 is rotatably connected to the rear support part 35, and the angle adjustment assembly 32 is disposed between the support arm 31 and the rear support part 35.

The support arm 31 comprises a first socket ring 33; the rear support part 35 comprises a second socket ring 34. Referring to FIGS. 2 and 3, the angle adjustment assembly 32 comprises a rotating shaft 40 and a damper 50 rotatably sleeving the rotating shaft 40; the first socket ring 33 is used in conjunction with the damper 50 and the second socket ring 34 is used in conjunction with the rotating shaft 40 to adjust the angle between the support arm 31 and the rear support part 35.

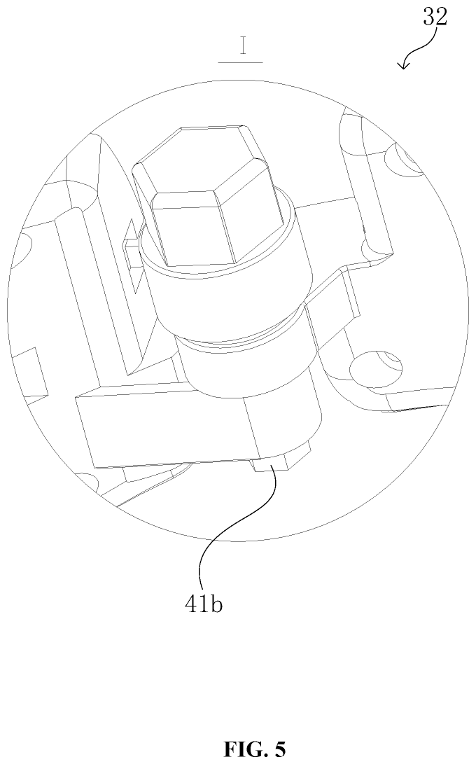

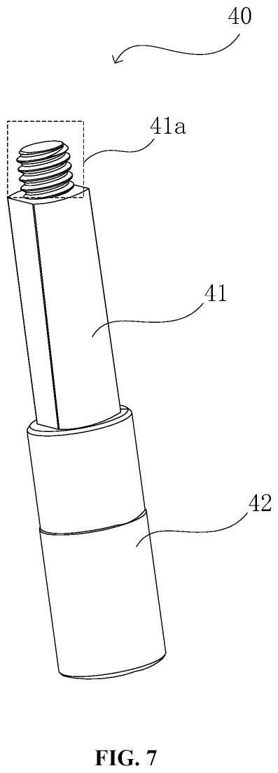

In certain examples, as shown in FIGS. 5-7, the rotating shaft 40 comprises a second fixing part 41 and a damping part 42; the second fixing part 41 comprises a distal end away from the damping part 42, and the distal end comprises a threaded end 41a. Referring to FIG. 2, the second fixing part 40 further comprises a threaded nut insert 41b screwed to the threaded end 41a; the second fixing part 41 has an irregular shape; the second socket ring 34 comprises a connection part matched with the second fixing part 41. The second fixing part 41 is disposed on the connection part and thus the second fixing part 41 cannot rotate relative to the connection part. The threaded nut insert 41b is screwed to the threaded end 41a to prevent the second socket ring 34 from sliding off the rotating shaft 40. The damper 50 and the first socket ring 33 are detachably sleeved on the damping part 42. As the support arm 31 rotates, the first socket ring 33 and the damper 50 rotate as well and can be arrested at any position.

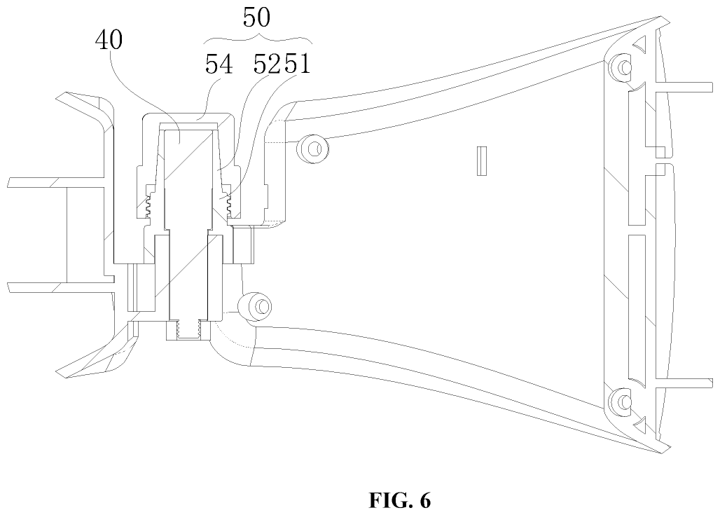

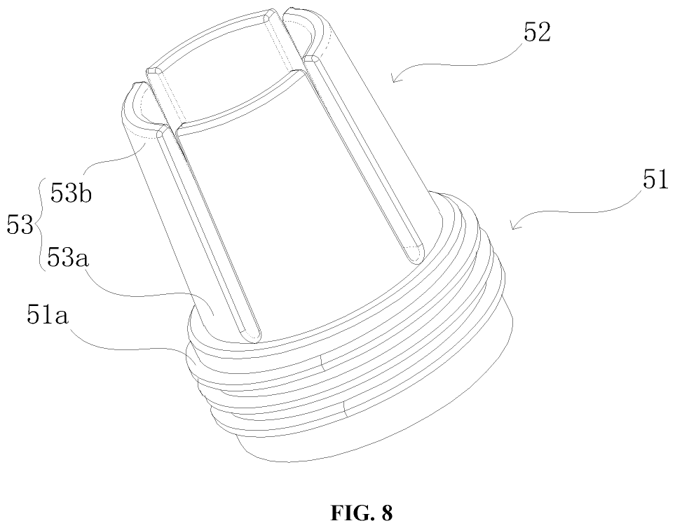

In certain examples, as shown in FIGS. 6 and 8, the damper 50 comprises a first fixing part 51 and an adjustment end 52 connected to the first fixing part 51. The first fixing part 51 comprises an external thread 51a. The first fixing part 51 comprises a distal end away from the adjustment end 52, and the first socket ring 33 is disposed on the distal end. The adjustment end 52 comprises a plurality of adjustment sections 53 disposed at equal intervals around the damping part 42. Each of the plurality of adjustment sections 53 comprises a first adjustment section 53a and a second adjustment section 53b connected to the first adjustment section 53a. The first fixing part 51 comprises a proximal end connected to the first adjustment section 53a. The first adjustment section 53a has a greater outer diameter than the second adjustment section 53b. The adjustment end 52 sleeves the rotating shaft 40. As the support arm 31 rotates, the adjustment end 52 can arrest the support arm 31 in any position. The plurality of adjustment sections 53 is easy to replace and is used to increase the durability and service life of the damper 50.

Preferably, the second socket ring 34 further comprises a first ring part (not shown) and a second ting part (not shown). A space is formed between the first ring part and the second ring part. The first socket ring 33 is inserted through the damper 50 and into the space. The rotating shaft 40 comprises two second fixing parts 41 which are inserted through the first ring part, the first socket ring 33, and the second ring part successively, to improve stability of the rotary frame 30.

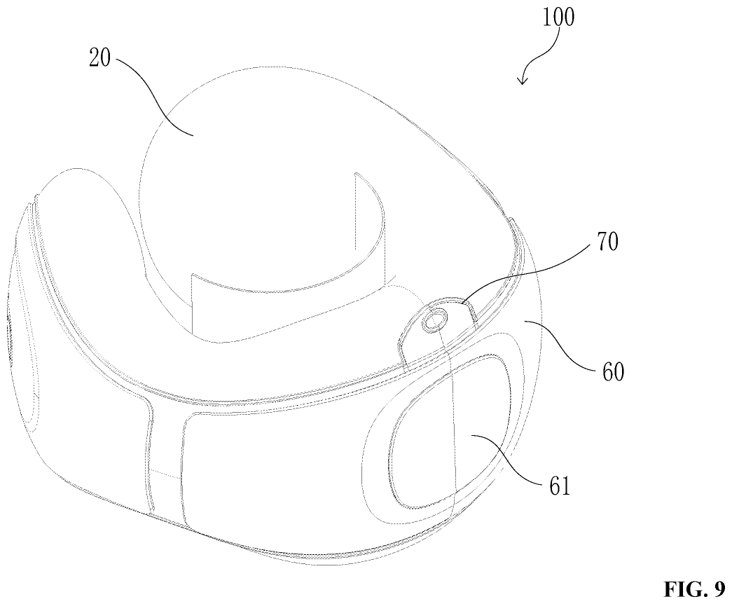

As shown in FIG. 9, the travel pillow 100 further comprises a casing 60, and optionally further comprises a groove 21. The rotary frame 30 is fixedly disposed on in the groove 21; the casing 60 is disposed on the rotary frame 30; and the rotary frame 30 is disposed between the main body 20 and the casing 60.

Preferably, the casing 60 comprises a pressure part 61, comprising a pressure surface; the main body comprises an external surface back against the notch; the pressure part is disposed on the external surface; and the pressure surface is a flat surface.

The pressure surface is positioned against an object to ensure the user's neck is propped up at a comfortable angle. When the pressure surface is a curved surface, the travel pillow may slip and slide around, thus diminishing the user experience.

Preferably, the casing 60 further comprises a tab 70, comprising a hang hole. When the travel pillow is not in use by the user, the hang hole allows the travel pillow to be placed on a hook, which makes it easier for the user to carry the travel pillow.

It will be obvious to those skilled in the art that changes and modifications may be made, and therefore, the aim in the appended claims is to cover all such changes and modifications.

What is claimed is:

1. A device, comprising;
a main body, the main body comprising at least one compartment;
at least one module, the at least one module being detachably disposed in the at least one compartment; and
a rotary frame disposed on an outer side of the main body;
wherein:
the rotary frame comprises a support arm, a rear support part, and an angle adjustment assembly; the support arm is rotatably connected to the rear support part, and the angle adjustment assembly is disposed between the support arm and the rear support part to adjust an angle between the support arm and the rear support part; and
the angle adjustment assembly comprises a rotating shaft and a damper rotatably sleeving the rotating shaft; the support arm comprises a first socket ring; the rear support part comprises a second socket ring; the first socket ring is connected to the support arm and sleeves the rotating shaft; the second socket ring is connected to the rear support part and sleeves the rotating shaft.

2. The device of claim 1, wherein the at least one module is a massage module, a heating module, a blowing module, or a combination thereof.

3. The device of claim 1, wherein the travel pillow further comprises a snap connector disposed between the at least one module and the at least one compartment.

4. The device of claim 3, wherein the snap connector comprises a snap disposed on the at least one module, and a slot disposed on the at least one compartment; and the at least one module is fastened to the at least one compartment through the cooperation of the snap and the slot.

5. The device of claim 1, wherein the at least one module is connected to the at least one compartment in a sliding way.

6. The device of claim 5, wherein a slide rail is disposed on the at least one compartment; the at least one module comprises a slider movable along the slide rail; so that the at least one module is slidably connected to the at least one compartment through the cooperation of the slide rail and the slider.

7. The device of claim 1, wherein the main body is bent to form a notch; the device further comprises a pressure part comprising a pressure surface; the main body comprises an external surface back against the notch; the pressure part is disposed on the external surface; and the pressure surface is a flat surface.

8. The device of claim 1, further comprising a casing, a filler, and a tab; wherein the casing is disposed on an exterior surface of the main body; the filler is disposed between the casing and the main body; the tab is connected to the filler and allows the travel pillow to be placed on a hook.
